(19) United States
(12) Patent Application Publication
(10) Pub. No.: US 2024/0030730 A1
(43) Pub. Date: Jan. 25, 2024

(54) Removable Battery Pack Comprising at least one Switching Element for Interrupting or Enabling a Charging or Discharging Current

(71) Applicant: Robert Bosch GmbH, Stuttgart (DE)

(72) Inventor: Holger Wernerus, Pliezhausen (DE)

(21) Appl. No.: 18/257,225

(22) PCT Filed: Dec. 16, 2021
(86) PCT No.: PCT/EP2021/086067

§ 371 Date: Jun. 13, 2023

(30) Foreign Application Priority Data
Dec. 21, 2020 (DE) 10 2020 216 369.3

(51) Int. Cl. H02J 7/00

(52) U.S. Cl. CPC H02J 7/0047; H02J 7/0029; H02J 7/0063; H02J 7/0045

(57) ABSTRACT

A removable battery pack includes a monitoring unit, an electromechanical interface, and at least one first switching element. The electromechanical interface includes a plurality of electrical contacts. A first electrical contact is configured to serve as a first power supply contact, to which a first reference potential is applied, and a second electrical contact is configured to serve as a second power supply contact, to which a second reference potential is applied. The at least one first switching element is configured to interrupt or enable a charging or discharging current across the first power supply contact and the second power supply contact. The monitoring unit is configured to control the at least one first switching element based on a switching potential. The switching potential is directly derived from the first reference potential. The switching potential is decoupled with respect to voltage fluctuations and voltage drops of the first reference potential.

The invention relates to a removable battery pack having a monitoring unit and at least one first switching element for interrupting or enabling a charging or discharging current according to the preamble of claim 1.

### THE PRIOR ART

A large number of electrical consumers are operated using removable battery packs requiring no tool use by the user (hereinafter referred to as removable battery packs), which are accordingly discharged by the electrical consumer and can be recharged using a charging device. Typically, such removable battery packs consist of a plurality of energy store cells interconnected in series and/or parallel in order to achieve a required removable battery pack voltage or capacitance. A particularly advantageous and quite high power and energy density can be achieved if the energy store cells are designed as, e.g., lithium ion cells (Li-ion).

It is known to design an electromechanical battery pack interface to be detachable without the use of tools from a further electromechanical interface of the electrical consumer or charging device. A respective one first electrical contact of the interfaces is in this case designed as an energy supply contact which can be supplied with a first reference potential, preferably a supply potential, and a respective one second electrical contact of the battery interfaces serves as an energy supply contact which can be supplied with a second reference potential, preferably a ground potential.

It is further known from DE 103 54 871 A1 to equip a removable battery pack with a switching element in the current path in order to interrupt or enable a charging or discharging current. The monitoring unit also monitors necessary operating parameters that are essential for the charging or discharging of the removable battery pack, e.g. a removable battery voltage, the individual cell voltages, a removable battery pack and/or cell temperature, the charging or discharging current, or the like.

Proceeding from the prior art, the problem addressed by the invention is to ensure reliable and fast switching of the at least one switching element for interrupting or enabling the charge or discharge current on the basis of an existing removable battery pack voltage without any voltage fluctuations of the removable battery pack voltage affecting the function of the switching element.

### Advantages of the Invention

In order to solve the aforementioned problem, it is provided that the monitoring unit controls the at least one first switching element by means of a switching potential which is directly derived from the first reference potential, in particular from the supply potential, and is decoupled with respect to voltage fluctuations and voltage drops of the first reference potential, in particular of the supply potential. By decoupling the switching potential from the first reference potential, a secure and stable function of the at least one first switching element can be ensured as far as possible independently of the removable battery voltage. In the event of drops in the removable battery voltage due to high load currents, this decoupling ensures a stable switching potential without also negatively affecting the slope of the switching flanks during regular switch-on and switch-off operations. At the same time, however, the switching potential is still provided directly by the already existing removable battery pack voltage, so that it is not necessary to generate the switching potential of typically >=10 V by further electronic components, e.g. additional voltage regulators.

Electrical consumers in the context of the invention should be understood to mean, e.g., power tools that can be operated using a removable battery pack for machining workpieces by means of an electrically driven insertion tool. The power tool can in this case be designed both as a hand-held power tool, or also as a stationary electric machine tool. Typical power tools in this context include hand or bench drills, screwdrivers, percussion drills, hammer drills, planers, angle grinders, orbital sanders, polishing machines, circular saws, table saws, crosscut saws and jigsaws, or the like. However, garden and construction equipment operated using a removable battery pack such as lawnmowers, lawn trimmers, branch saws, motor and ditching mills, robotic breakers and excavators, or the like, as well as household equipment operated with a removable battery pack such as vacuum cleaners, mixers, etc., can also be considered as electrical consumers. The invention is likewise applicable to electrical consumers which are simultaneously supplied using a plurality of removable battery packs.

The voltage of a removable battery pack is typically a multiple of the voltage of a single energy store cell and results from the interconnection (parallel or in series) of the individual energy store cells. An energy store cell is typically designed as a galvanic cell comprising a structure in which a cell pole comes to rest on one end and another cell pole comes to rest on an opposite end. In particular, the energy store cell comprises a positive cell pole at one end and a negative cell pole at an opposite end. Preferably, the energy store cells are formed as lithium-based energy store cells, e.g., Li-ion, Li-po, Li-metal, or the like. However, the invention can also be applied to removable battery packs having Ni—Cd, Ni—MH cells, or other suitable cell types. In conventional Li-ion energy store cells with a cell voltage of 3.6 V, voltage classes result of, e.g., 3.6 V, 7.2 V, 10.8 V, 14.4 V, 18 V, 36 V, etc. Preferably, an energy store cell is designed as an at least substantially cylindrical round cell, the cell poles being arranged at ends of the cylindrical shape. However, the invention does not depend on the type and design of the energy store cells used, but can instead be applied to any removable battery packs and energy store cells, e.g. pouch cells or the like, in addition to round cells.

One embodiment of the invention provides that the decoupled switching potential is formed by an RC element consisting of at least one resistor and at least one capacitor, in which case the RC element is switched between the first and the second reference potential, in particular between the supply potential and the ground potential, and the switching potential is applied between the at least one resistor and the at least one capacitor.

To protect the RC element from a short circuit between the two reference potentials, in particular between the supply potential and the ground potential, it is decoupled from the first reference potential, in particular the supply potential, by a protective diode, in particular a Schottky diode. A Schottky diode also offers the advantage of a lower voltage drop, so that a higher voltage is available for switching the at least one first switching element.

The at least one resistor of the RC element is dimensioned such that its resistance value does not produce any heat that is hazardous for the removable battery pack in the event of a short circuit within the removable battery pack electronics. Such a short circuit can, e.g., arise from a faulty capacitor of the RC element, from a fault in the monitoring unit, or from a driver circuit driven by the latter. In the prior art, a rather small resistance value of significantly less than 1 kΩ is usually selected in order to not limit the switching current for the at least one first switching element too much in terms of fast switching times. However, this has the disadvantage that such a resistor would be overloaded in the event of a short circuit, which requires an additional fuse element. In order to avoid this, the resistance value of the at least one resistor is set at least to 1 kΩ and the disadvantage of insufficient switching current is compensated for by a sufficiently high capacitance of the capacitor of the RC element. The at least one capacitor of the RC element has dimensions such that its capacitance is in this case greater than the sum of all capacities of the removable battery that are charged when the at least one first switching element is turned on. In addition, the capacitance of the at least one capacitor should be at least so large that the switching potential decreases sufficiently slowly in the event of an interrupting removable battery voltage, in order to be able to switch the at least one first switching element for a certain period of time. In addition, the high-impedance design of the RC element provides an advantage in that the switching potential for the at least one first switching element is largely decoupled from short circuits at or in the removable battery pack.

In addition, the RC element has dimensions such that the time constant resulting from the product of the resistance value of the at least one resistor and the capacitance of the at least one capacitor does not cause unfavorably high charging times of the at least one capacitor of the RC element for the operation of the removable battery pack, which could negatively influence a switching on of the at least one first switching element. The risk of functional impairments or performance losses of the removable battery pack can be effectively reduced due to the resulting avoidance of switching times that are too long or switching potentials that build up too slowly before the at least one first switching element is switched on.

In addition, it is provided that the switching potential can be applied to the at least one first switching element by means of a half-bridge consisting of two further switching elements. The half-bridge consists of a second and a third switching element, in which case the second switching element serving as a high side switch is preferably designed as a P channel MOSFET or as a PNP bipolar transistor and the third switching element serving as a low side switch is preferably designed as an N channel MOSFET or as an NPN bipolar transistor. In a particularly advantageous manner, at least a second and third resistor is switched between a tapping of the RC element for the switching potential and the half-bridge and/or between a center tap of the half-bridge and a control input of the at least one first switching element, in particular a gate of the MOSFET.

The at least one second and/or the third resistor are sized such that, due to their resulting resistance value, the switching current required for a fast switching of the at least one first switching element is not too low and, on the other hand, in the event of a short-circuit or if the second and third switching element are accidentally switched on simultaneously, there is no heat generation that is hazardous for the removable battery pack. Particularly advantageously, the resulting resistance value of the at least a second and/or third resistor should be significantly less than 1 kΩ. In addition, optimized dimensions of the at least one second resistor has the effect that the currents that may occur as a result of switching the second switching element, which is designed as a high side switch, do not result in excessive component stress, which could lead to premature aging, in particular of the second switching element and the at least one second resistor and thus to damage to the removable battery pack.

### Exemplary Embodiments

### DRAWINGS

The invention is explained hereinafter with reference to FIGS. 1 and 2 by way of example, whereby identical reference characters in the drawings indicate identical components having an identical function.

Shown are:

FIG. 1: a schematic view of system comprising at least one removable battery pack and at least one charging device connectable to the removable battery pack for charging, or an electrical consumer connectable to the removable battery pack for discharging the removable battery pack, and

FIG. 2: a block diagram of the system of FIG. 1 for charging the removable battery pack with a charger.

### DESCRIPTION OF THE EXEMPLARY EMBODIMENTS

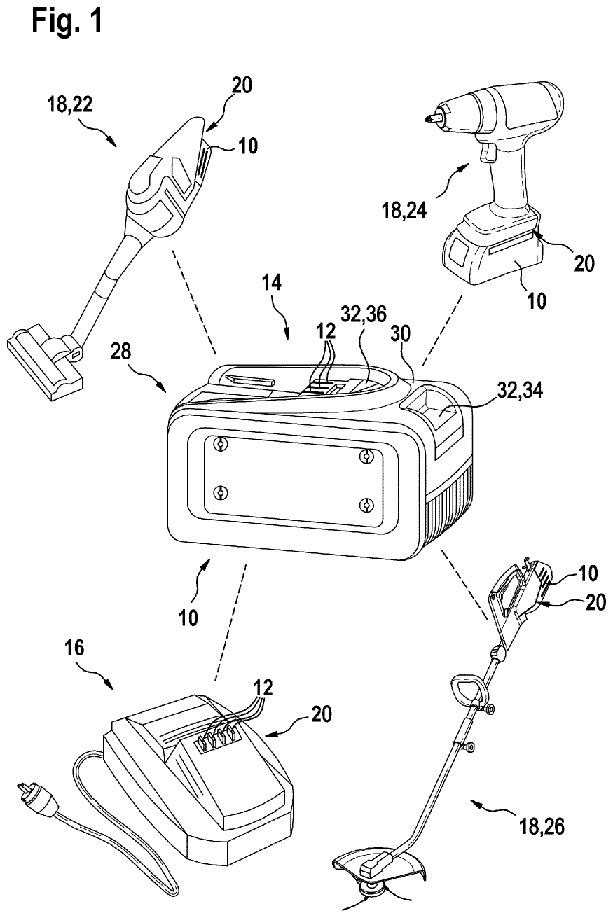

FIG. 1 shows a removable battery pack 10 with an electromechanical interface 14 having a plurality of electrical contacts 12. The removable battery pack 10 can be charged by means of a charging device 16 and discharged by various electrical consumers 18. To this end, the charging device 16 and the electrical consumers 18 each comprise a further electromechanical interface 20 having a plurality of electrical contacts 12. FIG. 1 is intended to illustrate that the invention is suitable for various electrical consumers 18. By way of example, a battery vacuum cleaner 22, a battery impact wrench 24, and a battery lawn trimmer 26 are shown. However, in the context of the invention, a wide variety of power tools, garden tools, and household appliances can be suitable as electrical consumers 18.

The removable battery pack 10 comprises a housing 28, a side wall or top side 30 of which comprises the electromechanical interface 14 for detachable connection with the further electromechanical interface 20 of the charging device 16 or the electrical consumers 18. In connection with the electrical consumer 18, the electromechanical interfaces 14, 20 are primarily used to discharge the removable battery pack 10, while, in connection with the charging device 16, they are used in order to charge the removable battery pack 10. The exact design of the electromechanical interfaces 14, 20 depends on various factors, e.g., the voltage class of the removable battery pack 10, or of the electrical consumer 18, and various manufacturer specifications. For example, it is also possible to provide three or more electrical contacts 12 for energy and/or data transmission between the removable battery pack 10 and the charging device 16. or the electrical consumer 18. A mechanical coding is also conceivable so that the removable battery pack 10 can be operated only on specific electrical consumers 18. Given that the mechanical design of the electromechanical interface 14 of the removable battery pack 10 and of the further electromechanical interface 20 of the charging device 16 or the electrical consumer 18 is irrelevant to the invention, it will not be discussed in further detail. Both the skilled person and a user of the removable battery pack 10 and of the charging device 16, or rather the electrical consumer 18, will make the appropriate selection in this respect.

The removable battery pack 10 comprises a mechanical locking device 32 for locking the positively and/or non-positively detachable connection of the electromechanical interface 14 of the removable battery pack 10 to the corresponding counter-interface 20 (not shown in detail) of the electrical consumer 18. The locking device 32 is in this case designed as a spring-loaded push button 34 that is operatively connected to a locking element 36 of the removable battery pack 10. Due to the resilience of the push button 34 and/or of the locking element 36, the locking device 32 automatically engages into the counter-interface 20 of the electrical consumer 18 upon insertion of the removable battery pack 10. If a user presses the push button 34 in the insertion direction, the locking is released and the user can remove or extend the removable battery pack 10 from the electrical consumer 18 in the direction opposite the insertion direction.

As previously mentioned hereinabove, the battery voltage of the removable battery pack 10 generally results from a multiple of the individual voltages of the energy store cells (not shown) as a function of their connection (in parallel or in series). The energy store cells are preferably designed as lithium-based energy store cells, e.g., Li-ion, Li-po, Li-metal, or the like. However, the invention can also be applied to removable battery packs having Ni—Cd, Ni—MH cells, or other suitable cell types.

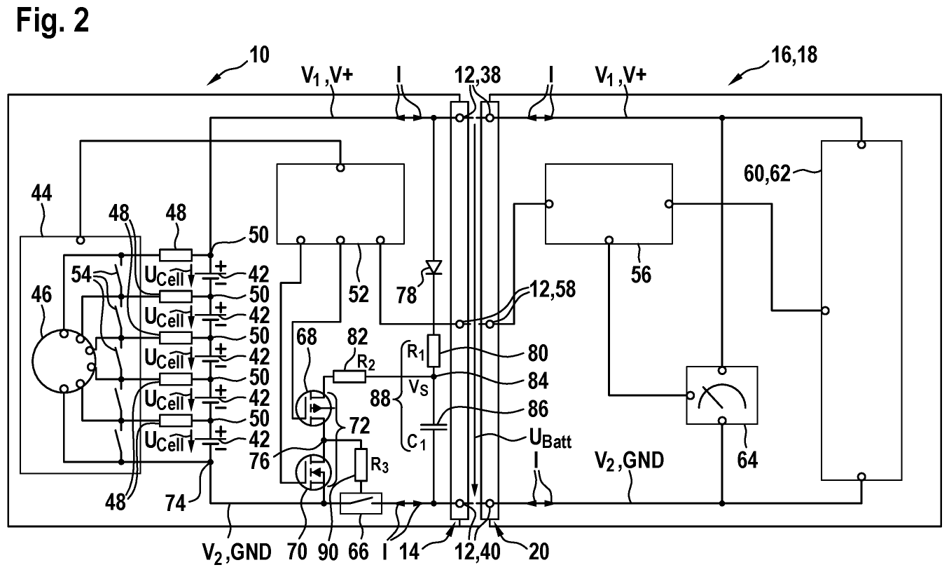

FIG. 2 shows a block diagram consisting of the removable battery pack 10 on the left side and a charging device 16, or rather the electrical consumer 18, on the right side. The removable battery pack 10 and charging device 16 (or electrical consumer 18) comprise the mutually corresponding electromechanical interfaces 14 and 20 having a plurality of electrical contacts 12, a respective one first electrical contact 12 of the interfaces 14, 20 serving as an energy supply contact 38 which can be supplied with a first reference potential V₁, preferably a supply potential V₊, and a respective one second electrical contact 12 of the battery interfaces 14, 20 serving as an energy supply contact 40 which can be supplied with a second reference potential V₂, preferably a ground potential GND. Via the first and the second energy supply contacts 38, 40, the removable battery pack 10 can, on the one hand, be charged by the charging device 16 with a charging current and, on the other hand, discharged by the electrical consumer 18 with a discharging current. The current strengths of the charge and the discharging current can differ significantly from one another. The discharging current in correspondingly designed electrical consumers 18 can be up to 10 times higher than the charging current of the charging device 16. The common symbol I will be used hereinafter despite said differences between the charge and discharge currents. The phrase “can be supplied” is intended to clarify that the potentials V₊ and GND, in particular in the case of an electrical consumer 18, are not permanently applied to the energy supply contacts 38, 40 but are only applied after connecting the electrical interfaces 14, 20. The same is true of a discharged removable battery pack 10 after connection to the charging device 16.

The removable battery pack 10 comprises a plurality of energy store cells 42, which are shown in FIG. 2 as a series circuit but can alternatively or additionally also be operated in a parallel circuit, in which case the series circuit defines the voltage U_{Batt} of the removable battery pack 10 dropping across the energy supply contacts 38, 40, while a parallel circuit of individual energy store cells 42 primarily increases the capacitance of the removable battery pack 10. As previously mentioned hereinabove, it is also possible to connect in series individual cell clusters consisting of energy store cells 42 connected in parallel in order to achieve a specific voltage U_{Batt} of the removable battery pack with simultaneously increased capacitance. In conventional Li-ion energy store cells 42 with a cell voltage U_{Cell} of 3.6 V each, a removable battery pack voltage U_{Batt}=V₁−V₂ of 5·3.6 V=18 V drops across the energy supply contacts 38, 40 in the present exemplary embodiment. Depending on the number of energy store cells 42 connected in parallel in a cell cluster, the capacitance of conventional removable battery packs 10 can be up to 12 Ah or more. However, the invention is not dependent on the type, design, voltage, power supply capability, etc. of the energy storage cells 42 used, but can be used for any removable battery pack 10 and energy storage cells 42.

A single-cell monitoring (SCM) pre-stage 44 is provided for monitoring the individual energy store cells 42 connected in series, or the cell clusters of the removable battery pack 10. The SCM pre-stage 44 comprises a multiplexer measuring device 46 which, via filter resistors 48, can be connected at a high impedance level to corresponding taps 50 of the poles of the energy store cells 42 or cell clusters. In the following, the term “energy store cell” is also intended to include the cell cluster since the former only influence the capacitance of the removable battery pack 10, but are equivalent with regard to the detection of the cell voltages U_{Cell}. The filter resistors 50, which are in particular designed at a high impedance level, can in particular prevent dangerous heating of the measurement inputs of the multiplexer measuring device 46 in the event of a fault.

The switching of the multiplexer measuring device 46 can be performed via a monitoring unit 52 integrated into the removable battery pack 10 or also directly within the SCM pre-stage 44. Additionally, in this way, switching elements 54 of the SCM pre-stage 44 connected in parallel to the energy store cells 42 can be closed or opened in order to thus effect what is referred to as balancing of the energy store cells 42 in order to achieve uniform charge and/or discharge states of the individual energy store cells 42. It is likewise conceivable that the SCM pre-stage 44 passes the measured cell voltages U_{Cell} to the monitoring unit 52 so that the actual measurement of the cell voltages U_{Cell} is performed directly by the monitoring unit 52, e.g., via a corresponding analog-digital converter (ADC).

The monitoring unit 52 can be designed as an integrated circuit in the form of a microprocessor, ASIC, DSP, or the like. It is likewise conceivable that the monitoring unit 52 consists of a plurality of microprocessors or at least in part of discrete components having corresponding transistor logic. In addition, the first monitoring unit 52 can comprise a memory for storing operating parameters of the removable battery pack 10, such as the voltage U_{Batt}, the cell voltages U_{Cell}, a temperature T, the charging or discharging current I, or the like.

In addition to the monitoring unit 52 in the removable battery pack 10, the charging device 16 or the electrical consumer 18 can also comprise a monitoring unit 56, which can be designed according to the monitoring unit 52 of the removable battery pack 10. The two monitoring units 52, 56 can communicate with one another via a third contact 12 of the electromechanical interfaces 14, 20 designed as a signal or data contact 58. For example, the two monitoring units 52, 56 can exchange necessary operating parameters essential to the charging process via the signal and data contact 58. It is also conceivable that the monitoring units 52, 56 can control one another in order to, e.g., cancel a charging or discharging operation or switch to another charging mode.

In the case of an electrical consumer 18, the monitoring unit 56 controls a load 60 connected to the first and the second power supply contacts 38, 40 of the further interface 20, which is adjacent the removable battery voltage U_{Batt}. The load 60 can, e.g., be designed as a power output stage that applies a pulse-width modulated signal to an electric motor to change its rotational speed and/or torque, which has a direct effect on the discharging current I of the removable battery pack 10. However, a load 60 consuming different power is conceivable as well. Numerous variants of possible electrical loads are known to the skilled person, so this will not be discussed in further detail.

Alternatively, the removable battery pack 10 inserted into a charging device 16 can be charged at the charging current I and the voltage U_{Batt} corresponding to the removable battery pack 10. For this purpose, the charging device 16 or its mains adapter 62 is provided with a mains connection (not shown). The voltage U_{Batt} applied to the energy supply contacts 38, 40 can be measured via a voltage measuring device 64 in the charging device 16 and evaluated by the monitoring unit 56. The voltage measuring device 64 can also be fully or partially integrated into the monitoring unit 56 of the charging device 16, e.g., in the form of an integrated ADC. The exact design of the mains adapter 60 of the charging device 16 is known to the skilled person and is of minor importance to the invention. Therefore, it will not to be discussed further herein.

In order to be able to interrupt or enable the charge or discharge current I also within the removable battery pack 10 in order to increase operational reliability, the removable battery pack 10 comprises at least one first switching element 66, which can be opened by the monitoring device 52 via a half-bridge 72 consisting of a second and a third switching element 68, 70 for interrupting the charge or discharge current I and closed to enable the charge or discharge current I. In the exemplary embodiment shown, the at least one first switching element 66 is arranged in the ground path (low side) between the second contact 12 designed as the power supply contact 40 of the electromechanical interface 14 and a ground contact point 74 of the SCM pre-stage 44. Alternatively or additionally, it is also possible to arrange at least one first switching element 66 in the high side path between the tap 50 of the SCM pre-stage 44 and the first contact 12 (designed as the power supply contact 38) of the electromechanical interface 14. Moreover, a plurality of first switching elements 66 can respectively be arranged in both the low side and the high side paths. Preferably, the at least one first switching element 66 is designed as a MOSFET. However, other switching elements, such as a relay, an IGBT, a bipolar transistor, or the like, are also conceivable.

Similar to the at least one first switching element 66, the two switching elements 68, 70 of the half-bridge 72 are likewise preferably designed as MOSFETs. However, other second and third switching elements 68, 70, such as relays, IGBTs, bipolar transistors or the like, are also conceivable. In the present exemplary embodiment, the second switching element 68, which is designed as a high side switch of the half-bridge 72, is a P channel MOSFET and the third switching element 70, which is designed as a low side switch of the half-bridge 72, is an N channel MOSFET. To interrupt the charge or discharge current I, the at least one first switching element 66 is now opened by the monitoring device 52 by closing the third switching element 70. The monitoring device 52 can moreover also open the second switching element 68, but this is not absolutely necessary. Conversely, the monitoring device 52 enables the charge or discharge current I by closing the at least one first switching element 66 by closing the second switching element 68 when the third switching element 70 is open. For this purpose, the half-bridge 72 is connected to the reference potential GND on the one hand and to the supply potential V₊ on the other hand via a protective diode 78 as well as a first resistor 80 and a second resistor 82, in which case a tap 84 between the first and the second resistor 80, 82 serves as the connection point for a capacitor 86, which is in turn connected to the second power supply contact 40 of the electromechanical interface 14. Thus, the capacitor 86 the second resistor 82 and the half-bridge 72 are connected in parallel to the at least one first switching element 66. Furthermore, a tap 76 between the two switching elements 68, 70 of the half-bridge 72 is connected via a third resistor 90 to a control input of the at least one first switching element 66, in particular to a gate terminal of the MOSFET.

The first resistor 80 and the capacitor 86 themselves form an RC element 88, the time constant t of which results from the product of the resistance value R 1 of the first resistor 80 and the capacity C₁ of the capacitor 86. Preferably, the time constant t is dimensioned such that no charging times of the at least one capacitor 86 result, which are disadvantageously high for the removable battery pack 10 and could negatively affect the switching on of the at least one first switching element 66. The risk of functional impairments or performance losses of the removable battery pack 10 can be effectively reduced due to the resulting avoidance of excessively long switching times or switching potentials that build up too slowly before the at least one first switching element 66 is switched on.

The RC element 88 is decoupled from a supply potential V₊ via the protective diode 78, which is preferably designed as a Schottky diode. As a result, the protective diode 78 protects the RC element 88 from a voltage dip between the supply potential V₊ and the ground potential GND. Designing the protective diode 78 as a Schottky diode also offers the advantage of a lower voltage drop, so that a higher voltage is available for switching the at least one first switching element 66.

The tap 84 between the first and the second resistor 80, 82 simultaneously forms a center tap of the RC element 88, where a decoupled switching potential Vs for switching the at least one first switching element 66 via the half-bridge 72 is provided. The first resistor 80 of the RC element 88 is in this case dimensioned such that its resistance value R 1 does not produce any heat that is hazardous to the removable battery pack 10 in the event of a short circuit. Such a short circuit can, e.g., occur internally due to a fault of the capacitor 86 of the RC element 88, a fault in monitoring unit 52 or half-bridge 72, but also externally due to dirty and shorted power supply contacts 38, 40. To avoid overloading the first resistor 80 by a short circuit, its resistance value R 1 is at least 1 kΩ. However, since this would limit the switching current for the at least one first switching element 66, the capacitor 86 of the RC element 88 must have a sufficiently high capacitance C₁. Ideally, the capacitance C₁ is sized to be significantly larger than the sum of all capacitances of the removable battery pack 10 that are charged when the at least one first switching element 66 is switched on. For example, a value of approximately 100 nF for the capacitance C₁ would be conceivable. However, in order to ensure a switching potential Vs, which only degrades slowly in the event of a short circuit, values of more than 1 μF for the capacitance C₁ are advantageous. In addition, the high-impedance design of the RC element provides an advantage in that the switching potential Vs for the at least one switching element 66 is largely decoupled from short circuits at or in the removable battery pack 10.

The switching potential Vs can then be applied by the monitoring device 52 via the half-bridge 72 as well as the second and third resistor 82, 90 in the manner described to a control input of the at least one first switching element 66, e.g., to the gate terminal of the MOSFET, in order to open it. The second and the third resistor 82 and 90 are in this case sized such that, due to their resulting resistance value R₂+R₃, the switching current required for a fast switching of the at least one first switching element 66 is not too low and, on the other hand, in the event of a short-circuit or if the second and third switching element 68, 70 of the half-bridge 72 are accidentally switched on simultaneously, there is no heat generation that is hazardous for the removable battery pack 10. Preferably, the resulting resistance value R₂+R₃ of the second and third resistors 82, 90 is significantly less than 1 kΩ. In addition, optimized sizing of the second resistor 82 has the effect that the currents that may occur as a result of switching the second switching element 68, which is designed as a high side switch, do not result in excessive component stress, which could lead to premature aging, in particular of the second switching element 68 and the second resistor 82 and thus to damage to the removable battery pack 10. In addition, a single resistor can be used instead of the second and third resistors 82, 90. Multiple resistors are also conceivable. The same applies to the number of capacitors and resistors of the RC element.

Finally, it should be noted that the exemplary embodiments shown are not limited to FIGS. 1 and 2, nor to the type of removable battery packs 10, charging device 16, or electrical consumers 18 shown therein. The same applies to the number of energy store cells 42 and the associated design of the multiplexer measuring device 46. In addition, the embodiments of the interfaces 14, 20 and the number of their contacts 12 shown are merely to be understood by way of example.

1. A removable battery pack comprising:
a monitoring unit;
an electromechanical interface including a plurality of electrical contacts, a first electrical contact configured to serve as a first power supply contact, to which a first reference potential is applied, and a second electrical contact configured to serve as a second power supply contact, to which a second reference potential is applied; and
at least one first switching element configured to interrupt or enable a charging or discharging current across the first power supply contact and the second power supply,
wherein the monitoring unit is configured to control the at least one first switching element based on a switching potential,
wherein the switching potential is directly derived from the first reference potential, and
wherein the switching potential is decoupled with respect to voltage fluctuations and voltage drops of the first reference potential.

2. The removable battery pack according to claim 1, in wherein:
the switching potential is formed by a resistor-capacitor element (RC element),
the RC element consists of at least one resistor and at least one capacitor,
the RC element is switched between the first reference potential and the second reference potential, and
the switching potential is applied between the at least one resistor and the at least one capacitor of the RC element.

3. The removable battery pack according to claim 2, wherein the RC element is decoupled from the first reference potential by a protective diode.

4. The removable battery pack according to claim 2, wherein the at least one resistor of the RC element has dimensions such that a its resistance value of the at least one resistor does not result in any heat generation that is hazardous for the removable battery pack.

5. The removable battery pack according to claim 4, wherein the resistance value of the at least one resistor is at least 1 kΩ.

6. The removable battery pack according to claim 2, wherein the at least one capacitor of the RC element has dimensions such that a capacitance of the at least one capacitor is larger than a sum of all capacitances of the removable battery pack that are loaded upon energization of the at least one first switching element.

7. The removable battery pack according to claim 2, wherein the RC element has dimensions such that a time constant resulting from a product of a resistance value of the at least one resistor and a capacitance of the at least one capacitor does not cause loading times of the at least one capacitator that are unfavorably high for operation of the removable battery pack.

8. The removable battery pack according to claim 2, wherein the switching potential is applied to a control input of the at least one first switching element using a half-bridge consisting of two further switching elements.

9. The removable battery pack according to claim 8, wherein at least a second resistor and a third resistor are switched between (i) a tap of the RC element for the switching potential and the half-bridge, and/or (ii) a center tap of the half-bridge and the control input of the first switching element.

10. The removable battery pack according to claim 9, wherein the second resistor and/or the third resistor have dimensions such that, due to a resulting resistance value of the second resistor and the third resistor, a switching current required for a rapid switching of the first switching element is not too low, and, in the event of a short-circuit, there is no heat generation that is hazardous for the removable battery pack.

11. The removable battery pack according to claim 10, wherein the resulting resistance value of the second resistor and the third resistor is significantly less than 1 kΩ.
